(19) United States
(12) Patent Application Publication
(10) Pub. No.: US 2006/0222782 A1
(43) Pub. Date: Oct. 5, 2006

(54) Method for evaluating orientation state of oriented layer, method for manufacturing liquid crystal panel, and method for inspecting liquid crystal panel

(75) Inventors: Etsuko Takei, Shimosuwa (JP); Takashi Hiraiwa, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/389,576

(22) Filed: Mar. 24, 2006

(30) Foreign Application Priority Data
Mar. 29, 2005 (JP) 2005-093625
Nov. 29, 2005 (JP) 2005-343339

(51) Int. Cl. C09K 19/52; C09K 19/38

(52) U.S. Cl. 428/1.1; 428/1.26

(57) ABSTRACT

A method for evaluating an orientation state of an oriented layer, comprising: applying, on the oriented layer, a solution of a light emitting polymer containing a fluorescent material that is capable of being oriented according to an orientation state of an underlying layer; performing a heat treatment on the applied solution of the light emitting polymer to form a light emitting polymer film; obtaining a polarized fluorescence spectrum of the light emitting polymer film; determining an orientation parameter using an orientation function equation based on the polarized fluorescence spectrum; and evaluating the orientation state of the oriented layer using the orientation parameter.

### CROSS-REFERENCE TO RELATED APPLICATION

Priority is claimed on Japanese Patent Application No. 2005-093625, filed Mar. 29, 2005, and Japanese Patent Application No. 2005-343339, filed Nov. 29, 2005, the contents of which are incorporated herein by reference.

### BACKGROUND

1. Technical Field

As a method for evaluating the orientation state of a thin film of molecules exhibiting an anisotropic molecular orientation, such as an oriented layer using in a liquid crystal apparatus which are imparted with an initial orientation of liquid crystal molecules, infrared spectrophotometry that employs linearly polarized infrared light has been widely used (see Arafune et. al, Appl. Phys. Lett., 71, 2755, p. 1997, for example). This technique measures the difference in a relative angle between the polarization direction of the intensity of infrared light that is transmitted through a sample (oriented layer) formed on a substrate and the sample direction with respect to the relative angle. In other words, this method evaluates the orientation direction by detecting dichroism that represents infrared absorption that varies depending on the orientation direction of molecules. However, this technique is only applicable to oriented layers formed on substrates that transmit infrared light, such as substrates of silicon, calcium fluoride (fluorite; CaF₂), or the like.

2. Related Art

Against this background, another method is proposed using infrared spectroscopic ellipsometry that determines the orientation state of molecules of sample thin films using FT-IR (Fourier transform infrared spectroscopy) by measuring the dependence on the incident angle of the polarization state of reflected light of infrared light incident on the thin film (see JP-A-2001-4534). Such a method using infrared spectroscopic ellipsometry enables measurements of liquid crystal oriented layers formed on a glass substrate, as well as layers formed on substrates that transmit infrared light, such as substrates of silicon, calcium fluoride, or the like.

However, the above-described technique using infrared spectroscopic ellipsometry suffers from a shortcoming in that measurements are dependent on the thickness of a sample and a requirement for the thicknesses of samples is limiting.

Furthermore, the sensitivity is lower in this method since infrared light in a low energy state is used, making it difficult to determine the orientation state of oriented layer in detail.

### SUMMARY

The invention was conceived in view of the above-mentioned situations, and an advantage of some aspects of the invention is to provide a method for evaluating an orientation state of an oriented layer that is capable of effectively evaluating the orientation state of an oriented layer, irrespective of the type of underlying substrate on which the oriented layer is formed or the thickness of the layer. Furthermore, another advantage of some aspects of the invention is to provide a method for manufacturing a liquid crystal panel and a method for inspecting a liquid crystal panel employing this method for evaluating an orientation state of an oriented layer.

A first aspect of the invention is directed to a method for evaluating an orientation state of an oriented layer, comprising: applying, on the oriented layer, a solution of a light emitting polymer containing a fluorescent material that is capable of being oriented according to an orientation state of an underlying layer; performing a heat treatment on the applied solution of the light emitting polymer to form a light emitting polymer film; obtaining a polarized fluorescence spectrum of the light emitting polymer film; determining an orientation parameter using an orientation function equation based on the polarized fluorescence spectrum; and evaluating the orientation state of the oriented layer using the orientation parameter.

According to the first aspect of the invention, a light emitting polymer film is formed on the oriented layer to be evaluated by applying the solution of the light emitting polymer that is capable of being oriented according to the orientation state of the underlying layer and performing a heat treatment, the resultant light emitting polymer film is oriented reflecting the orientation state of the underlying layer, i.e., the oriented layer. Accordingly, it is possible to evaluate the orientation state of an oriented layer indirectly from the orientation state of the light emitting polymer film by measuring a polarized fluorescence spectrum (carrying out polarized fluorescence spectrography) to determine the orientation state of this light emitting polymer film and obtaining an orientation parameter using an orientation function equation based on the thus obtained measurement results. As a result, the orientation state of an oriented layer can be effectively evaluated irrespective of the type of underlying substrate on which the oriented layer is formed or the thickness of the oriented layer. Furthermore, such a method can detect subtle differences in orientation states since fluorescent light provides higher sensitivity than infrared light. Furthermore, the method can detect the orientation state in smaller areas in which detection sensitivity is reduced using conventional techniques, while being capable of measuring the orientation state in a wider area.

The method for evaluating an orientation state of the invention is particularly preferred for evaluating the orientation state of an oriented layer using in a liquid crystal apparatus, such as a polyimide film.

Furthermore, by applying the solution of the light emitting polymer on the oriented layer using a spin coating method, it is possible to form a light emitting polymer film uniformly in a relatively small thickness, thereby enabling formation of a light emitting polymer film that is better oriented reflecting the orientation state of the underlying oriented layer.

A second aspect of the invention is directed to a method for manufacturing a liquid crystal panel, the liquid crystal panel having a first substrate, a second substrate, and a liquid crystal being sandwiched between the first substrate and the second substrate, comprising: forming a first oriented layer above an inner surface of the first substrate; forming a second oriented layer above an inner surface of the second substrate; evaluating an orientation state of the respective oriented layers of the first substrate and the second substrate using the method for evaluating an orientation state of an oriented layer according to the first aspect to determine whether the oriented layer has a good orientation state; and attaching the first substrate and the second substrate which are determined as having a good orientation state together to assemble the liquid crystal panel.

According to the second aspect of the invention, since the orientation state of the oriented layer is evaluated after formation of the oriented layer using the above-described method for evaluating an orientation state of an oriented layer, it is possible to effectively evaluate the orientation state of the oriented layer. Accordingly, by assembling the liquid crystal panel using the first substrate and the second substrate which are determined as having a good orientation state it is possible to prevent occurrence of failure of the liquid crystal panel caused by an orientation failure of the oriented layers. Furthermore, with such an evaluation of the orientation state, the formation steps of the oriented layer can be managed.

A third aspect of the invention is directed to a method for manufacturing a liquid crystal panel, the liquid crystal panel having a first substrate, a second substrate, and a liquid crystal being sandwiched between the first substrate and the second substrate, comprising: forming a first oriented layer above an inner surface of the first substrate; forming a second oriented layer above an inner surface of the second substrate; evaluating an orientation state of the respective oriented layers of the first substrate and the second substrate using the method for evaluating an orientation state of an oriented layer according to the first aspect to determine whether the oriented layer has a good orientation state; and attaching the first substrate and the second substrate which are determined as having a good orientation state together to assemble the liquid crystal panel.

According to the third aspect of the invention, by evaluating a liquid display panel assembled from a first substrate and a second substrate upon inspecting the liquid display panel by means of sampling or the like, it is possible to effectively evaluate (inspect) an orientation state of the oriented layers using the method for evaluating an orientation state of an oriented layer according to the third aspect of the invention, as described previously. Accordingly it is possible to prevent occurrence of failure of the liquid crystal panel caused by the orientation failure of the oriented layer. Furthermore, with such an evaluation of the orientation state, the formation steps of the oriented layer can be managed.

Furthermore, in the method for inspecting a liquid crystal panel according to the third aspect of the prevent invention, the method may comprise performing a reliability test prior to the disassembling the liquid crystal panel to determine whether the liquid crystal panel is good, and the disassembling the liquid crystal panel may comprise disassembling the liquid crystal panel that is determined as not being good during the reliability test.

This facilitates making a determination as to whether the cause of the failure is attributable to the orientation state of the oriented layers with ease.

### BRIEF DESCRIPTION OF THE DRAWINGS

The invention will be described with reference to the accompanying drawings, wherein like numerals reference like elements:

FIG. 1 is a schematic diagram illustrating an example of a fluorescence spectrometer used for the invention;

FIG. 2 is a perspective view illustrating the placement of a sample upon measurement;

FIG. 3 is a graph showing the measurement results of the polarized fluorescence spectrogram;

FIG. 4 is a graph showing the measurement results of the polarized fluorescence spectrogram;

FIG. 5 is a graph showing the measurement results of the polarized fluorescence spectrogram;

FIG. 6 is a graph showing the measurement results of the polarized fluorescence spectrogram;

FIG. 7 is a plan view of a liquid crystal panel as viewed from an opposing substrate side;

FIG. 8 is a cross-sectional view taken along the line H-H′ in FIG. 7;

FIG. 9 is a flowchart illustrating a manufacturing process of a liquid crystal panel; and

FIG. 10 is a flowchart illustrating an inspection process of a liquid crystal panel.

### DESCRIPTION OF EXEMPLARY EMBODIMENTS

A detailed description of the invention will be described.

First, a method for evaluating an orientation state of an oriented layer according to the invention will be explained.

The method for evaluating an orientation state of an oriented layer according to the invention is particularly preferably used for evaluating the orientation state of an oriented layer using in a liquid crystal apparatus having a liquid crystal panel. Oriented layers used in liquid crystal apparatuses (liquid crystal panels) are typically made of polyimide, and are generally formed in a desired orientation state by forming the film via a transparent electrode made of ITO formed above a glass substrate and performing a rubbing treatment. Other than polyimide, inorganic oriented layers made of SiO₂, Al₂O₃, or the like, formed using the oblique deposition technique or the like, are used as oriented layers used in liquid crystal apparatuses for some applications. Accordingly, such inorganic oriented layers are to be evaluated according to the invention.

In this embodiment, an oriented layer to be evaluated is a polyimide film that is formed via a transparent electrode (ITO) formed above a glass substrate, and is subjected to a rubbing treatment. It should be noted that commonly-known techniques for forming liquid crystal apparatuses are used for formation of the polyimide film above the glass substrate and the rubbing treatment.

After such an oriented layer is obtained as the subject to be evaluated, a solution of a light emitting polymer containing a fluorescent material that is capable of being oriented according to an orientation state of an underlying layer is applied on this oriented layer. Although the method for applying the solution is not particularly limited and various techniques may be used, the spin coating method is preferably used since it enables formation of a light emitting polymer film having a small and highly uniform thickness.

As the light emitting polymer, for example, poly (9,9-dioctylfluorenyl-2,7-diyl), of which the terminal is capped by a dimethylphenyl group, is preferably used. Furthermore, other than poly (9,9-dioctylfluorenyl-2,7-diyl), polymers containing a fluorene backbone are preferably used. A solution of the light emitting polymer may be prepared by dissolving this polymer into a solvent in which the polymer is soluble, such as p-xylene or 1,3,5-trimethylbenzene, so that the concentration of the polymer is 1% by weight, for example. This light emitting polymer solution may be applied on the above-described oriented layer formed above the glass substrate with the spin coating method. It should be noted that the light emitting polymer is not limited to the above-described compounds, and any fluorescent materials that are capable of being oriented according to an orientation state of the underlying layer may be used.

After the obtained light emitting polymer solution is applied with the spin coating method in the above-described manner, the resultant film is subjected to a heat treatment to obtain a light emitting polymer film that has an orientation state. The conditions of the heat treatment are not particularly limited, and an example includes, for example, heating at a temperature of 180° C. for about two hours followed by leaving standing at room temperature for two to three hours to cool down slowly. As discussed by L. M. Herz and R. T. Phillips, “Effects of interchain interactions, polarization anisotropy, and photo-oxidation on the ultra-fast photoluminescence decay from a polyfluorene,” Physical Review B, Vol. 61, No. 20, p. 691-697, for example, the above-described light emitting polymer film is oriented well reflecting the orientation state of the underlying layer, i.e., an oriented layer in such a heat treatment. Accordingly, it is possible to indirectly determine the orientation state of the oriented layer to be evaluated by determining the orientation state of this light emitting polymer film.

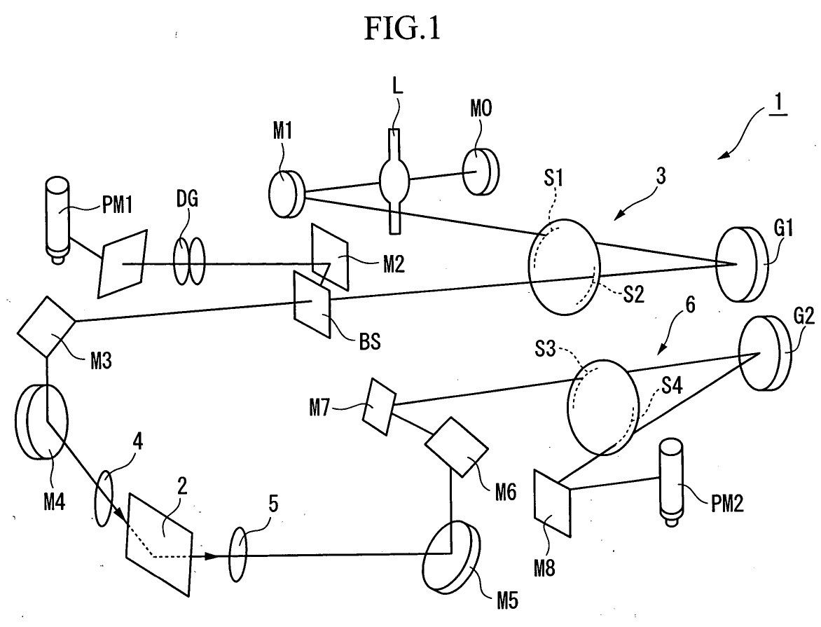

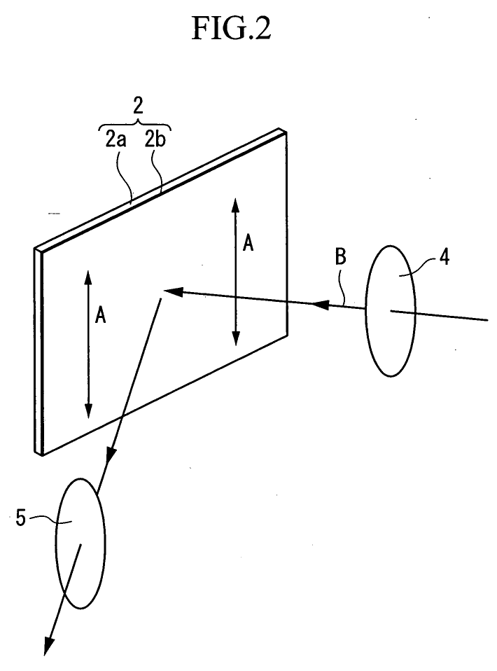

More specifically, after the formation of the light emitting polymer film, the polarized fluorescence spectrum of this light emitting polymer film is obtained using a fluorescence spectrometer. FIG. 1 is a schematic diagram illustrating one example of a fluorescence spectrometer used for this measurement, and reference numeral 1 denotes a fluorescence spectrometer and reference numeral 2 denotes a sample to be measured. The sample 2 is the light emitting polymer film described above which is formed on an oriented layer formed above a glass substrate, and the glass substrate is mounted at a predetermined sample location. It should be noted that the sample 2 is mounted so that a glass substrate 2a having the oriented layer and a transparent electrode formed thereabove is held upright by a holding member (not shown) and the excitation side light B is incident on the side on which the light emitting polymer film 2b is formed, as shown in FIG. 2. The sample 2 is mounted upright so that the orientation direction of the oriented layer, i.e., the direction indicated by an arrow A in FIG. 2, coincides with the vertical direction, i.e., the direction normal to the ground.

Once the sample 2 is mounted, light is emitted from a light source L having a xenon lamp (having a power of 150 W) of the fluorescence spectrometer 1 shown in FIG. 1. The light emitted from the light source L is focused on an entrance slit S1 of an excitation side spectroscope 3 by an elliptical mirror M1 and a concave mirror M0. The incident light from the entrance slit S1 is diffracted by a diffraction grating G1 and a desired monochromatic light is selected by an exit slit S2. A part of the monochromatic light is directed by a quartz beam splitter BS, a concave mirror M2 and a beam attenuator DG to a photomultiplier PM1 for monitoring. On the other hand, the monochromatic light that passes through the beam splitter BS is directed to a light polarizer 4 by a plane mirror M3 and a toroidal mirror M4 in which the monochromatic light is polarized. The polarized monochromatic light is directed to and focused on the sample 2.

The sample 2 emits fluorescent light when the above-described monochromatic light is incident on the light emitting polymer film. This fluorescent light from the light emitting polymer film is polarized by a light polarizer 5, and then is focused on an entrance slit S3 of a fluorescent light side spectroscope 6 by a toroidal mirror M5 and plane mirrors M6 and M7. It should be noted that the fluorescent light side spectroscope 6 has the same configuration as that of the excitation side spectroscope 3 described above. The fluorescent light from the entrance slit S3 is diffracted by a diffraction grating G2, and the light from the exit slit S4 is directed to a photomultiplier PM2 by a concave mirror M8.

In the fluorescence spectrometer 1 having such a configuration, various combinations of vertical polarization (0°) and parallel polarization (90°) are used for the excitation (Ex) side light polarizer 4, which is on the entrance side, and the fluorescent light (Em) side light polarizer 5. More particularly, measurements are taken using respective light polarizers in combination under the following three conditions (1)-(3):

(1) The excitation side light polarizer 4 with parallel polarization (90°) and the fluorescent light side light polarizer 5 with parallel polarization (90°)

(2) The excitation side light polarizer 4 with parallel polarization (90°) and the fluorescent light side light polarizer 5 with vertical polarization (0°)

(3) The excitation side light polarizer 4 with vertical polarization (0°) and the fluorescent light side light polarizer 5 with vertical polarization (0°)

It should be noted that a measurement under each of the conditions (1)-(3) is carried out while the sample 2 is held so that the orientation direction of the oriented layer is oriented in the vertical direction (in the direction normal to the ground).

The polarized fluorescence spectrogram is carried out under each of these conditions, and using well-known orientation function equations that are discussed in Akiharu Kobayasi et. al, “Photoluminescence Anisotropy of Ultraviolet-Light-Irradiated Organic Polysilane-Silica Hybrid Thin Films,” Jpn. J. Phys., Vol. 41 (2002), p.p. L1467-L1470), Part 2, No. 12B, 15, Dec. 2002, for example, an orientation parameter f₂₀ (referred to as S₂ in the above-described paper) is obtained based on the thus obtained measurement results.

More specifically, the result obtained by a measurement under Condition (1) is denoted by I_{VVV}, the result obtained by a measurement under Condition (2) is denoted by I_{VVH}, and the result obtained by a measurement under Condition (3) is denoted by I_{VHH}. These measurement results are substituted into the following Eqs. (1) and (2) to obtain the orientation parameter f₂₀.
cos²θ=(I_{VVV}+2I_{VVH})/{(8/3)I_{VHH}+4I_{VVH}+I_{VVV}} Eq. (1)
f₂₀=(3 cos²θ−1)/2 Eq. (2)

For each of the above-described results I_{VVV}, I_{VVH}, and I_{VHH} obtained from the measurements of the polarized fluorescence spectrogram, values at a wavelength in which the fluorescence intensity is maximized in each of the polarized fluorescence spectra (spectral band intensity) are used.

The orientation parameter f₂₀ obtained from Eqs. (1) and (2) in the above manner represents the degree of orientation (orientation state) of the film measured (light emitting polymer film) in a range of 0≦f₂₀≦1, and this parameter can indicate particular locations of orientation failures and the states of orientation failures. More specifically, when f₂₀ is zero, the light emitting polymer film is not oriented at all, which indicates that the underlying layer of the light emitting polymer film, i.e., the oriented layer, is not oriented at all. Furthermore, when f₂₀ is 1, the light emitting polymer film is completely oriented, which indicates that the underlying layer of the light emitting polymer film, i.e., the oriented layer, is completely oriented.

Accordingly, it is possible to evaluate the above-described orientation state of an oriented layer that is the test subject using the orientation parameter f₂₀. More specifically, the required degree of orientation of the oriented layer and the reference orientation parameters f₂₀ that give the required degree of orientation may be decided through experiments or the like in advance. After the formation of an oriented layer followed by the rubbing treatment, the orientation parameter f₂₀ is determined for the resultant oriented layer using the above-described method. The orientation state, i.e., pass or fail, of the oriented layer can be evaluated by determining whether the thus obtained orientation parameter f₂₀ is higher than these reference orientation parameters f₂₀ or falls within their range. Furthermore, it is possible to identify the locations of orientation failures by varying measured locations of the oriented layer as appropriate.

It should be noted that the required degree of orientation (orientation state) of an oriented layer may vary depending on the type of liquid crystal for a liquid crystal apparatus in which the oriented layer is used. For example, when the liquid crystal employed is a nematic phase liquid crystal, the required degree of orientation f₂₀ is about 0.5. Accordingly, it is preferred that the oriented layer be formed under the conditions that give f₂₀ of about 0.5 when a nematic phase liquid crystal is employed.

Furthermore, as described below, when determining pass or failure of the orientation state of an oriented layer, the orientation parameter f₂₀ obtained through measurements in the above-described manner (hereinafter, referred to as a measured orientation parameter f₂₀(x)) is compared with the reference orientation parameter f₂₀ corresponding to the required degree of orientation (hereinafter, the upper limit of the reference orientation parameter f₂₀ is referred to as f₂₀(a) and the lower limit of the reference orientation parameter f₂₀ is referred to as f₂₀(b)). When the measured orientation parameter f₂₀(x) is within the range between the reference orientation parameters f₂₀(a) and f₂₀(b), the orientation state of an oriented layer is determined as good; otherwise, the orientation state of an oriented layer is determined as not being good.

More specifically, when the following Eq. (3) is satisfied, the orientation state of an oriented layer is evaluated as good; otherwise, the orientation state of an oriented layer is determined as not being good (fail).
f₂₀(b)≦f₂₀(x)≦f₂₀(a) Eq. (3)

As for the reference orientation parameters f₂₀ corresponding to the required degree of orientation, it should be noted that only the lower limit value may be set without setting the upper limit value (f₂₀(a)) depending on the type of liquid crystal employed. More specifically, when the following Eq. (4) is satisfied, the orientation state of an oriented layer is evaluated as good; otherwise, the orientation state of an oriented layer is determined as not being good (fail).
f₂₀(b)≦f₂₀(x) Eq. (4)

### Experiment Examples

The correlation between the degrees of orientation (orientation state) of oriented layers and the orientation parameters f₂₀, obtained from light emitting polymer films described above was confirmed through experiments.

Eight samples were prepared by forming a film of ITO on a glass substrate and forming a polyimide film (oriented layer) thereon. Next, these samples were subjected to a rubbing treatment under four different conditions (rubbing intensity conditions) described below. It should be noted that two samples were rubbing treated under each condition.

Samples #1 and #2 Rubbing intensity: “Strongest”

(Number of rotations of roll: 500 rpm and rubbing table shift speed: 20 (mm/sec))

Samples #3 and #4 Rubbing intensity: “Medium”

(Number of rotations of roll: 300 rpm and rubbing table shift speed: 120 (mm/sec))

Samples #5 and #6 Rubbing intensity: “Weak”

(Number of rotations of roll: 200 rpm and rubbing table shift speed: 200 (mm/sec))

Samples #7 and #8 Rubbing intensity: “None”

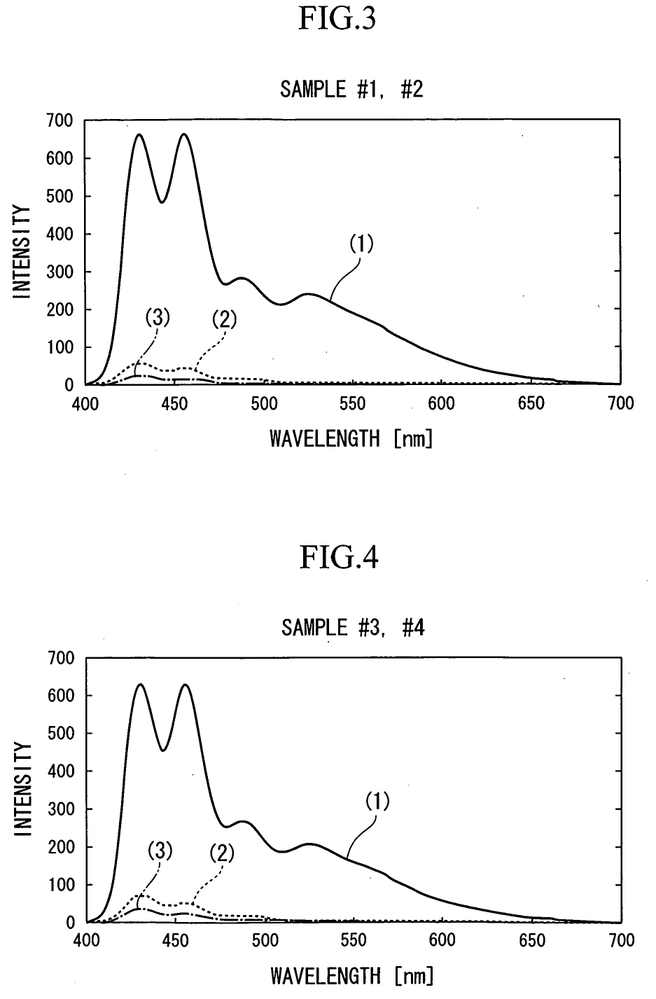

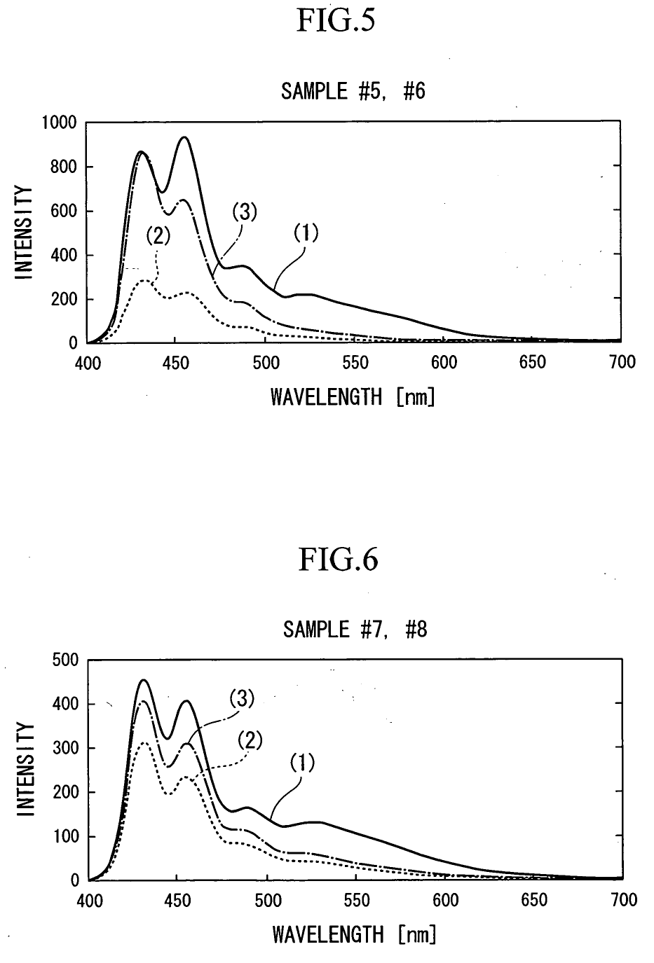

A light emitting polymer film was formed on the polyimide film (oriented layer) that was subjected to the rubbing treatment under each of the above conditions. A polarized fluorescence spectrum is then obtained using the above-described fluorescence spectrometer 1 for each of the thus formed light emitting polymer films. It should be noted that the polarized fluorescence spectrography is carried out while setting the light polarizers 4 and 5 to Conditions (1)-(3) described previously for each measurement. The results obtained from Samples #1 and #2 are shown in FIG. 3, the results obtained from Samples #3 and #4 are shown in FIG. 4, the results obtained from Samples #5 and #6 are shown in FIG. 5, and the results obtained from Samples #7 and #8 are shown in FIG. 6. It should be noted that measurement results shown in each graph are based on the average value of the respective two samples.

In the graphs in FIGS. 3 to 6, the horizontal axis represents the wavelength and the vertical axis represents the spectral band intensity.

Furthermore, in these graphs, the line (1) indicates the measurement results obtained under the above-described Condition (1), the line (2) indicates the measurement results obtained under the above-described Condition (2), and the line (3) indicates the measurement results obtained under the above-described Condition (3).

A maximum intensity is selected across the entire wavelength range from the three measurement results of each of the graphs in FIGS. 3 to 6. Herein, the graph in FIG. 3 with a maximum rubbing intensity is used as a reference, and the wavelength that gives the maximum intensity is selected from the three measurement results. An intensity in this wavelength is determined for each of Conditions (1)-(3), and the intensity under Condition (1) is denoted as I_{VVV}, the intensity under Condition (2) is denoted as I_{VVH} and the intensity under Condition (3) is denoted as I_{VHH}.

More specifically, in FIG. 3, a maximum intensity is obtained at a wavelength of about 460 nm under Condition (1), and the spectral band intensities at a wavelength of 460 nm are determined for lines (1)-(3) as I_{VVV}, I_{VVH}, and I_{VHH}. Similarly, the spectral band intensities at a wavelength of 460 nm are determined for lines (1)-(3) as I_{VVV}, I_{VVH}, and I_{VHH} in FIGS. 4 to 6, respectively.

Then, f₂₀ was obtained from I_{VVV}, and I_{VVH}, and I_{VHH} of each of the rubbing treatment conditions using the above-described Eqs. (1) and (2). The resultant results are shown as follows:

Samples #1 and #2 (Rubbing intensity: “strongest”): f₂₀=0.72

Samples #3 and #4 (Rubbing intensity: “medium”): f₂₀=0.65

Samples #5 and #6 (Rubbing intensity: “weak”): f₂₀=0.01

Samples #7 and #8 (Rubbing intensity: “none”): f₂₀=0.08

From the obtained values of f₂₀, Samples #1 and #2 in which the rubbing intensity was the “strongest” gave the greatest orientation parameter f₂₀ of 0.72, followed by Samples #3 and #4 with the rubbing intensity of “medium” which gave the second greatest orientation parameter f₂₀ of 0.65. Furthermore, the orientation parameters f₂₀ of the samples with the rubbing intensity of “weak” or “none” were significantly smaller than those of samples of “strongest” or “medium.”

Accordingly, it was confirmed that the degrees of orientation of the oriented layers and the values of the orientation parameter f₂₀ obtained from the above-described light emitting polymer film exhibit a good correlation, and that the orientation parameter f₂₀ is increased with an increase in the degree of orientation of the oriented layer while the orientation parameter f₂₀ is reduced with a reduction in the degree of orientation of the oriented layer.

In the above-described example, the graph in FIG. 3 with a maximum rubbing intensity is used as a reference, and the wavelength that gives the maximum intensity is selected from the three measurement results. However, it should be noted that the graph in FIG. 6 may be used as a reference and the wavelength that gives the maximum intensity is selected from the three measurement results. In that case, results similar to the above example were obtained for the orientation parameter f₂₀.

According to method for evaluating an orientation state of an oriented layer described above, it is possible to evaluate the orientation state of an oriented layer indirectly from the orientation state of the light emitting polymer film by performing the polarized fluorescence spectrogram to determine the orientation state of the underlying film, i.e., the light emitting polymer film, and obtaining an orientation parameter f₂₀ using an orientation function equation based on the thus obtained measurement results. As a result, the orientation state of an oriented layer can be effectively evaluated with detailed information on an orientation failure state, irrespective of the type (material) of underlying substrate on which the oriented layer is formed or the thickness of the oriented layer.

Furthermore, such a method can detect subtle differences in orientation states since fluorescent light provides higher sensitivity than infrared light. Furthermore, the method can detect the orientation state in smaller areas in which detection sensitivity is reduced using conventional techniques, while being capable of measuring the orientation state in a wider area.

It should be noted that the invention is not limited to the above-described embodiment and various modifications are possible without departing from the spirit of the invention. For example, although polyimide is used for an oriented layer to be evaluated in the above-described embodiment, an inorganic oriented layer may be used as the test subject instead of such an organic oriented layer, as described previously.

Furthermore, as for the oriented layer, instead of an oriented film for a liquid crystal apparatus (liquid crystal panel), an oriented layer made of an oriented film, or an oriented layer exhibiting orientation by means of fibers may be used as the test subject and the invention may be applied to these samples, for example.

Next, a method for manufacturing a liquid crystal panel according to the invention will be explained as a technique employing the method for evaluating an orientation state of an oriented layer.

This method for manufacturing a liquid crystal panel is a method for manufacturing a liquid crystal panel in which a liquid crystal is sandwiched between a first substrate and a second substrate.

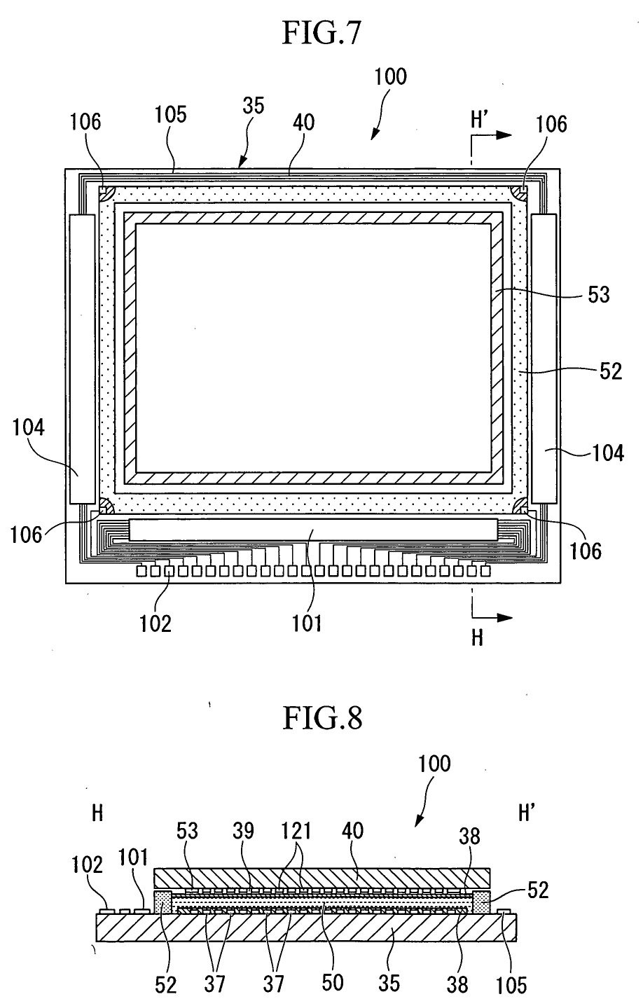

First, the liquid crystal panel will be explained. FIG. 7 is a plan view showing each component of the liquid crystal display panel as viewed from an opposing substrate side. FIG. 8 is a cross-sectional view taken along the line H-H′ in FIG. 7.

In FIGS. 7 and 8, in a liquid crystal display panel 100, a TFT array substrate (first substrate) 35 and an opposing substrate (second substrate) 40, which make a pair, are adhered with a sealing material 52 which is a photo-curing sealing agent. Furthermore, as shown in FIG. 8, the TFT array substrate (first substrate) 35 and the opposing substrate (second substrate) 40 each have electrodes 37 and 39 made of ITO or the like formed on the respective inner surface, and oriented layers 38 are formed covering these electrodes 37 and 39. The sealing material 52 is formed in a closed frame shape in the area on the surface of the substrate and liquid crystal 50 is enclosed and held in a region partitioned by this sealing material 52.

A peripheral parting 53 which is made of a light blocking material is formed in the interior region of the formation region of the sealing material 52, as shown in FIG. 7. In the outer region of the sealant 52, a data line driving circuit 101 and a mounting terminal 102 are formed along one side of the TFT array substrate 35, and a scanning line driving circuit 104 is formed along two sides adjacent to this one side. A plurality of wirings 105 for connecting between scanning line driving circuits 104 provided in both sides of the image display region is provided in the remaining one side of the TFT array substrate 35. In addition, in at least one location of corner sections of the opposing substrate 40, an inter-substrate conductive material 106 for electrically connecting between the TFT array substrate 35 and opposing substrate 40 is arranged.

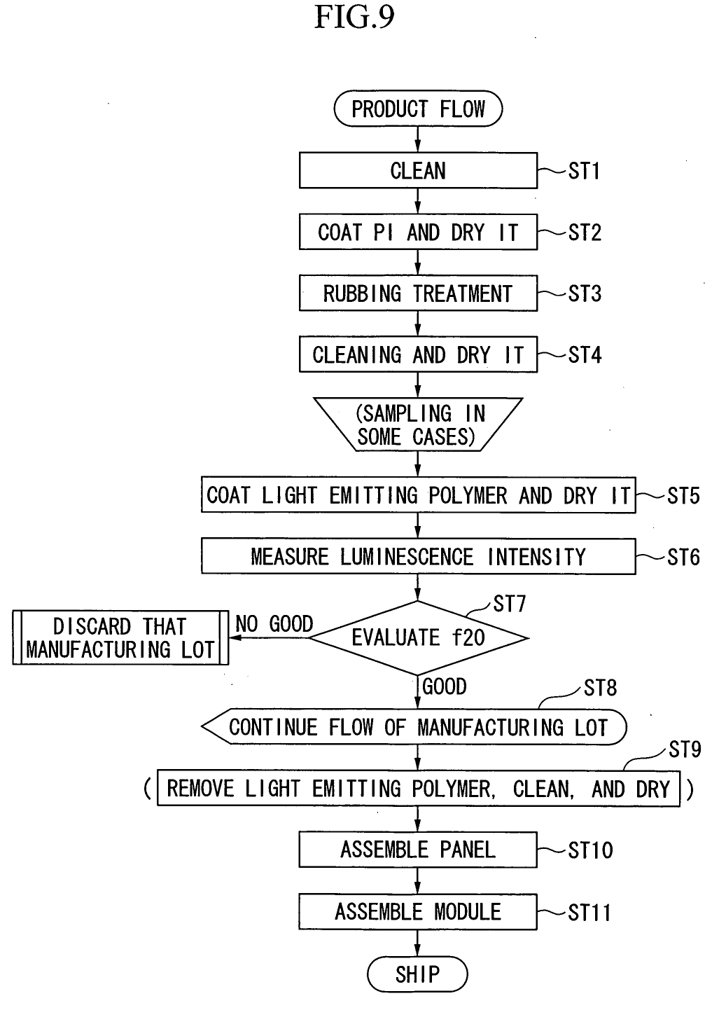

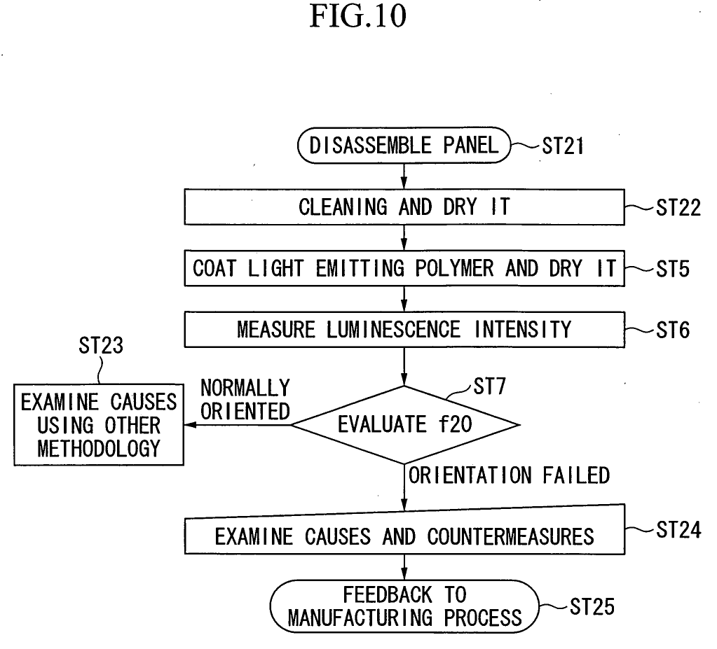

For manufacturing the liquid crystal panel 100 having such a structure, manufacturing steps are generally carried out following the flowchart shown in FIG. 9.

First, substrates of the TFT array substrate (first substrate) 35 and the opposing substrate (second substrate) 40 prior to the formation of an oriented layer are prepared. More specifically, for the TFT array substrate (first substrate) 35, a substrate is prepared wherein the data line driving circuit 101 and the scan line driving circuit 104 described above are formed and then an electrode (pixel electrode) 37 is formed. Furthermore, for the opposing substrate (second substrate) 40, a substrate is prepared wherein a color filter (not shown) is formed and then an electrode (transparent electrode) 39 is formed.

Next, the thus prepared substrates 35 and 40 are respectively cleaned (indicated by step ST1 in FIG. 9; hereinafter the symbols of steps refer to the steps in this figure).

Next, the oriented layer 38 is formed on an inner surface of each of the substrates (the first substrate and the second substrate) 35 and 40 that have been cleaned and dried. When polyimide is used for the oriented layer, the formation of the oriented layer 38 includes an application and drying of polyimide step (step ST2), a rubbing treatment step (step ST3) and a cleaning and drying step (step ST4). When an inorganic oriented layer made of SiO₂ or the like is formed using the oblique deposition technique, the formation of the oriented layer 38 includes an oriented layer formation step (not shown) using the oblique deposition and a cleaning and drying step.

Once preparation of the TFT array substrate (first substrate) 35 and the opposing substrate (second substrate) 40 is completed by forming the oriented layer 38 above each of the substrates, the orientation state of the oriented layer 38 is evaluated by a 100% inspection or sampling inspection. Upon evaluating the orientation state of the oriented layer 38, the method for evaluating an orientation state of an oriented layer according to the invention that has been described above is used.

More specifically, the light emitting polymer solution containing a fluorescent material that is capable of being oriented according to an orientation state of an underlying layer is formed on the respective oriented layer 38 on each of the substrates (the first substrate and the second substrate) 35 and 40. More specifically, the above-described poly (9,9-dioctylfluorenyl-2,7-diyl), of which the terminal is capped by a dimethylphenyl group, or the like is applied using the spin coating method or the like, and the resultant film is subjected to a heat treatment to obtain a light emitting polymer film (step ST5).

Next, the polarized fluorescence spectrum (fluorescence intensity) of the light emitting polymer films is obtained (step ST6), as described previously.

Then, the orientation parameter f₂₀ is calculated based on the obtained measurement results of the polarized fluorescence spectrography using the above orientation function equations Eqs. (1) and (2). The orientation states of the oriented layers are evaluated using the calculated orientation parameters f₂₀, and the pass or fail thereof, i.e., either normally oriented (good) or orientation failure (no good), is determined (step ST7).

In this example, as described previously, the evaluation of the orientation state of the oriented layer (determination of the orientation state) is made based on the resultant measured orientation parameter f₂₀(x), and the upper limit value f₂₀(a) and the lower limit value f₂₀(b) of the reference orientation parameter corresponding to the required degree of orientation or only the lower limit value f₂₀(b) of the reference orientation parameters using the above-described Eq. (3) or (4) to determine pass or fail. It should be noted that the upper limit value f₂₀(a) and the lower limit value f₂₀(b) of the reference orientation parameter corresponding to the required degree of orientation are determined through experiments or the like in advance, as described previously.

After such an evaluation of pass or fail, when the orientation state of the oriented layer 38 is determined as not being good, i.e., orientation failure, the evaluated substrate is discarded. Furthermore, when the inspection (evaluation) is carried out by sampling, the manufacturing lot containing this evaluated substrate is discarded. At this time, in order to identify the cause of the orientation failure, that is, if the failure is caused by any of steps ST2 through ST4 or other steps, the evaluation results (inspection results) are fedback for analysis.

On the other hand, when the orientation state of the oriented layer 38 is evaluated as good, i.e., normally oriented, the evaluated substrate is sent to the next step. Furthermore, when the inspection (evaluation) is carried out by sampling, a manufacturing lot containing this evaluated substrate is sent to the next step. The light emitting polymer film is removed from the evaluated substrate, and the substrate is further cleaned and dried (step ST9). It should be noted that in this processing step (step ST9), when the test subjects sampled are only a small portion of the manufacturing lot, for example, the test subjects may be discarded and the rest of the manufacturing lot may be sent to the next step.

In the above-described manner, once the first substrate and the second substrate 35 and 40 of which the orientation states of the oriented layers 38 are evaluated as good, i.e., normally oriented, are prepared, these substrates are attached and bonded together with the above-described sealing material 52. The liquid crystal panel 100 is then assembled by filling liquid crystal 50 within the area partitioned by the sealing material 52 to make it sandwiched between the substrates 35 and 40 (step ST10). Then, the reliability of the obtained liquid crystal panel 100 is evaluated as a product by performing various reliability tests, such as an electric test, a visual inspection, and a durability inspection.

Next, the liquid crystal panel 100 (or the manufacturing lot containing this liquid crystal panel 100) the reliability of which has been determined as good is assembled as a module by attaching a flexible printed wiring board (FPC) or the like and enclosing the liquid crystal panel 100 into a casing (step ST11). The reliability of the obtained module is again evaluated by performing various reliability tests, such as an electric test and a visual inspection.

Thereafter, the module the reliability of which has been determined as good is finished as a final product where necessary, and is shipped as a product.

In such a method for manufacturing a liquid crystal panel, since the orientation state of the oriented layer 38 is evaluated (in step ST7) after formation of the oriented layer 38 using the method for evaluating an orientation state of an oriented layer according to the invention, it is possible to effectively evaluate the orientation state of the oriented layer 38, as described previously. Accordingly, by assembling the liquid crystal panel 100 using the TFT array substrate (first substrate) 35 and the opposing substrate (second substrate) 40 having the oriented films the orientation states of which are evaluated as good it is possible to prevent occurrence of failure of the liquid crystal panel 100 caused by an orientation failure of the oriented layer 38. Furthermore, with such an evaluation of the orientation state, the formation steps of the oriented layer 38 (steps ST2 through ST4) can be adjusted upon occurrence of an orientation failure, for example, by feedbacking the evaluation results (inspection results).

Next, a method for inspecting a liquid crystal panel according to the invention will be explained as an application of the method for evaluating an orientation state of an oriented layer according to the invention.

In this method for inspecting a liquid crystal panel, an orientation state of an oriented layer is evaluated and inspected after the panel assembly step (step ST10) in the flowchart shown in FIG. 9. More specifically, as shown in FIG. 8, this method is a method for evaluating and inspecting the orientation state of the oriented layer 38 of the liquid crystal panel 100 in which oriented layers 38 formed on each inner surface of the TFT array substrate (first substrate) 35 and the opposing substrate (second substrate) 40, the first substrate and the second substrate are attached and bonded together with the sealing material 52, and the liquid crystal 50 is filled within the area partitioned by the sealing material 52 to make it sandwiched between the substrates 35 and 40.

Accordingly, in this inspection method, the liquid crystal panels 100 to be inspected are those after the panel assembly step (step ST10) shown in the flow of FIG. 9. First, the liquid crystal panel 100 the reliability of which as a product is evaluated as failed in the reliability test after an assembly of the liquid crystal panel 100 will be inspected. Second, the liquid crystal panel 100 within a module the reliability of which is evaluated as failed in the reliability test after an assembly as the module will be inspected. Finally, the liquid crystal panel 100 in a product assembled as a final product before shipping, or the liquid crystal panel 100 in a shipped product will be inspected. It should be noted that a test subject liquid crystal panel 100 in a product before or after shipping may be liquid crystal panels sampled at a final sampling inspection before shipping, liquid crystal panels to be inspected to which excess shock or vibration is applied in an accident during transportation to assure the quality of the product, or liquid crystal panels a quality inspection of which is required due to failure or the like.

In order to inspect such a liquid crystal panel 100, steps are generally carried out following the flowchart shown in FIG. 10.

First, the liquid crystal panel 100 to be inspected is taken out of the product, and the obtained liquid crystal panel 100 is disassembled into the TFT array substrate (first substrate) 35 and the opposing substrate (second substrate) 40 (shown as step ST21 in FIG. 10; hereinafter the symbols of steps refer to the steps in this figure). It should be noted that when the module assembly (step ST11) has not been carried out, the liquid crystal panel 100 may be disassembled.

Next, these substrates are each cleaned and dried (step ST22).

Then, an orientation state of the oriented layer 38 of each of the substrates after cleaning and drying is evaluated. For evaluating the orientation state of the oriented layer 38, the method for evaluating an orientation state of an oriented layer according to the invention described above is used. More specifically, the orientation state of the oriented layer is evaluated by performing the steps of forming a light emitting polymer film (step ST5), carrying out polarized fluorescence spectrography on the light emitting polymer film (by means of measuring the fluorescence intensity) (step ST6), and evaluating the orientation parameter f₂₀ obtained based on the results of the polarized fluorescence spectrography (step ST7), as shown in the flow of FIG. 9.

Then, if the orientation state of the oriented layer has been determined as normally oriented in the evaluation, a cause other than the failure of the orientation state of the oriented layer is identified using a different methodology when the product fails the reliability test (step ST23). Then, a countermeasure is taken by feedbacking the results for preventing a future occurrence of the failure.

On the other hand, when the orientation state of the oriented layer is evaluated as an orientation failure, the cause of the orientation failure is identified using methodologies including electrical or optical techniques, such as inspection under a microscope, and the countermeasure is examined (step ST24). For example, it is examined whether the orientation failure occurred due to some problems in the rubbing treatment, or residual contaminant due to insufficient cleaning, and an appropriate countermeasure is taken. Then, a future occurrence of the failure is prevented by feedbacking the results of the analysis to the manufacturing process (step ST25).

According to such a method for inspecting a liquid crystal panel, by evaluating the liquid display panel 100 assembled from the TFT array substrate (first substrate) 35 and the opposing substrate (second substrate) 40 upon inspecting the liquid display panel 100 by means of a final sampling test or the like, it is possible to effectively evaluate (inspect) the orientation state of the oriented layer 38 using the method for evaluating an orientation state of an oriented layer as described above. Accordingly it is possible to prevent occurrence of failure of the liquid crystal panel 100 caused by the orientation failure of the oriented layer 38. Furthermore, with such an evaluation of the orientation state, the formation steps of the oriented layer 38 (steps ST2 through ST4) can be adjusted when it has been determined as an orientation failure, for example, by feedbacking the evaluation results (inspection results).

Furthermore, especially when the liquid crystal panel 100 to be inspected is one of which the liquid crystal panel is determined to have failed in a reliability test, it is possible to determine whether the cause of the failure is attributable to the orientation state of the oriented layers 38 with ease. Accordingly, causes of product failures can be analyzed with ease and high precision.

While preferred embodiments of the invention have been described and illustrated above, it should be understood that these are examples of the invention and are not to be considered as limiting. Additions, omissions, substitutions, and other modifications can be made without departing from the spirit or scope of the invention. Accordingly, the invention is not to be considered as being limited by the foregoing description, and is only limited by the scope of the appended claims.

What is claimed is:

1. A method for evaluating an orientation state of an oriented layer, comprising:
applying, on the oriented layer, a solution of a light emitting polymer containing a fluorescent material that is capable of being oriented according to an orientation state of an underlying layer;
performing a heat treatment on the applied solution of the light emitting polymer to form a light emitting polymer film;
obtaining a polarized fluorescence spectrum of the light emitting polymer film;
determining an orientation parameter using an orientation function equation based on the polarized fluorescence spectrum; and
evaluating the orientation state of the oriented layer using the orientation parameter.

2. The method for evaluating an orientation state of an oriented layer according to claim 1, wherein the oriented layer is an oriented layer using in a liquid crystal apparatus.

3. The method for evaluating an orientation state of an oriented layer according to claim 2, wherein the oriented layer is made of a polyimide.

4. The method for evaluating an orientation state of an oriented layer according to claim 1, wherein the applying, the oriented layer, of the solution of the light emitting polymer comprises applying the solution of the light emitting polymer using a spin coating method.

5. A method for manufacturing a liquid crystal panel, the liquid crystal panel having a first substrate, a second substrate, and a liquid crystal being sandwiched between the first substrate and the second substrate, comprising:
forming a first oriented layer above an inner surface of the first substrate;
forming a second oriented layer above an inner surface of the second substrate;
evaluating an orientation state of the respective oriented layers of the first substrate and the second substrate using the method for evaluating an orientation state of an oriented layer according to claim 1 to determine whether the oriented layer has a good orientation state; and
attaching the first substrate and the second substrate which are determined as having a good orientation state together to assemble the liquid crystal panel.

6. A method for inspecting a liquid crystal panel, the liquid crystal panel having a first substrate having a first oriented film formed above an inner surface thereof, a second substrate having a second oriented film formed above an inner surface thereof, and a liquid crystal sandwiched between the first substrate and the second substrate, comprising:
disassembling the liquid crystal panel into the first substrate and the second substrate; and
inspecting an orientation state of an oriented layer of at least one of the first substrate and the second substrate using the method for evaluating an orientation state of an oriented layer according to claim 1.

7. The method for inspecting a liquid crystal panel according to claim 6, further comprising performing a reliability test prior to the disassembling the liquid crystal panel to determine whether the liquid crystal panel is good,
wherein the disassembling the liquid crystal panel comprises disassembling the liquid crystal panel that is determined as not being good during the reliability test.
